(19) United States
(12) Patent Application Publication
(10) Pub. No.: US 2009/0261603 A1
(43) Pub. Date: Oct. 22, 2009

(54) Handheld device for grappling animal excreta

(76) Inventor: Makar Boghozian, Granada Hills, CA (US)

Correspondence Address: Law Offices of Frederick Gotha, 301 East Colorado Blvd., Suite 800, Pasadena, CA, 91101, US

(21) Appl. No.: 12/148,155

(22) Filed: Apr. 17, 2008

(51) Int. Cl. A01K 29/00

(52) U.S. Cl. 294/1.3

(57) ABSTRACT

The invention relates to a handheld device for grappling animal excreta into a plastic bag that is subsequently removed from a roll of plastic bags without tearing the bag and spilling its contents. The device consists of a pair of opposing jaws which are pivotally carried by a pin member and biased by a torsion spring to urge the jaws to a closed position. A roll of plastic bags is carried in telescopic relationship with the pin member which are fed tangentially into the device. The leading edge portion of the plastic bag is advanced through the lower edges of the opposing jaws and then overlapped such that excreta may be surrounded by the leading edge portion and grappled into the plastic bag by closure of the jaws. The sidewalls of the jaws have lateral edges that are serrated and mesh upon closure of the jaws for gripping the succeeding plastic bag to permit the excreta containing bag to be separated from the roll without being torn.

### FIELD OF THE INVENTION

This invention relates to a manually operated device for grappling animal excreta into a plastic bag which is thereafter easily separable from the device.

### BACKGROUND OF THE INVENTION

Devices for picking up and disposing of the excreta of household pets, particularly when the excreta is initially stored in a plastic container bag for subsequent disposal, are well known in the prior art. These devices have not only been dictated by the sanitation requirements of urban and suburban communities but also by the need to eliminate aesthetic blight to those communities caused by the presence of unremoved animal excreta. To minimize this blight and to promote a cleaner environment, animal owners routinely pick up after their animals and deposit the excreta in a plastic container bag which they carry with them until it can be deposited into a waste container. In those devices where the plastic bag containers are carried on spools or rolls, i.e., where successive plastic bag containers must be separated from the roll at some point in order to discard the container with its excreta contents, the plastic containers have striated separations to facilitate the tearing of the container away from the roll. Where the excreta is grappled into the container, the eventual separation of the container from the roll thereafter requires a substantial pull to tear the bag along the striations that can induce unwanted tearing elsewhere and spillage from the container. It is desirable, therefore, to provide a grappling device that incorporates a multiplicity of plastic containers which feed tangentially from a spool or that may roll be separated from the roll striations without elsewhere tearing the container thereby inducing consequent spillage.

### SUMMARY OF THE INVENTION

In accordance with the present invention, an improved household device is therefore provided for grappling animal excreta in a plastic container bag and removing the container from the device without tearing the container thereby avoiding consequent spillage.

The handheld animal excreta grappling device of the present invention consists generally of a pair of opposing jaws, or first and second bodies, pivotally mounted to a pin member where the first and second bodies are biased toward a closed position. Both first and second bodies have lower abutting edges when in the closed position that are tapered for facilitating the grappling of the excreta. A roll of plastic container bags is telescopically carried by the pin member and may be tangentially fed manually such that the leading edge portion of the container bag may be manually positioned to project between and overlap the lower edges. Angular displacement of the bodies thereafter relative to each other expands the leading edge portion sufficiently to permit the excreta to be surrounded and subsequently grappled. The first and second bodies have meshing lateral edges that preferably have saw-tooth type serrations for gripping the plastic container to enable the user to easily separate each of the containers from the roll.

The preferred embodiment of the handheld device of this invention comprises a pin member having a horizontal axis and a first body pivotally carried by the pin member where the first body has a first open region which is partly bounded by opposing sidewalls having first lateral edges which are substantially orthogonal to the horizontal axis. The first body has a lower first edge where the first body is so dimensioned and proportioned such that its lateral edges and lower edge are at least in part in the same plane. The handheld device further has a second body pivotally carried by the pin member where the second body has a second open region which is partly bounded by opposing sidewalls having second lateral edges that are substantially orthogonal to the horizontal axis. The second body has a lower second edge and is so dimensioned and proportioned such that its lateral edges and lower edge are at least in part in the same plane. The first and second bodies are biased to return to a closed position by a spring member where the lower edges of the first and second bodies are in abutting relationship when closed, and the spring is responsive to angular displacement of the first body with respect to the second body to apply a restoring force to bring the lower edges to a compressive bearing engagement.

The pin member also carries a spool or roll of plastic container bags where each bag has a leading edge portion and a trailing edge portion and the spool or roll is carried by the pin member to permit each container bag to be sequentially advanced tangentially from the roll and positioned partly within the first and second open regions. The leading edge portion in positioning the container to permit grappling of the excreta projects through the lower edges and overlaps them such that angular displacement of the first body with respect to the second body will permit the leading edge portion to expand and surround the excreta.

After the excreta is surrounded and grappled, the plastic container bag containing the excreta may be temporarily stored within the first and second open regions. To remove a container bag by tearing through its striations without failure of the container bag by the undo stress of the separation of the container from the roll, the lateral first and second edges of the first and second bodies, respectively, have a meshing saw tooth shape to firmly grip the succeeding container bag at its leading edge portion to permit easy separation of the excreta container bag from the leading edge portion of the next container bag.

### BRIEF DESCRIPTION OF THE DRAWINGS

These and other features and advantages will become appreciated as the same become better understood with reference to the following specification, claims, and drawings wherein:

FIG. 1 is a perspective view of the improved animal excreta grappling device of this invention.

FIG. 2 is a rear view of the grappling device illustrated in FIG. 1.

FIG. 3 is a perspective view of the improved animal excreta grappling device illustrating the first and second bodies in the open position.

FIG. 4 is a side view of the open grappling device illustrated in FIG. 3.

FIG. 5 is a perspective view of the open grappling device of this invention illustrating the advancement of the plastic container bag tangentially from a roll of plastic container bags rotationally carried by the pin member of the device.

FIG. 6 is a perspective view illustrating the grappling device in part in phantom where the plastic container's leading edge portion is overlapped over the first and second bodies to permit the excreta shown in phantom to be grappled within the leading edge portion upon closure of the bodies.

FIG. 7 is a perspective view of the grappling device of this invention illustrating the next plastic container bag's leading edge portion cinched by the closure of the first and second bodies for separating the trailing edge of the excreta container from the leading edge portion of the next container bag.

### DETAILED DESCRIPTION

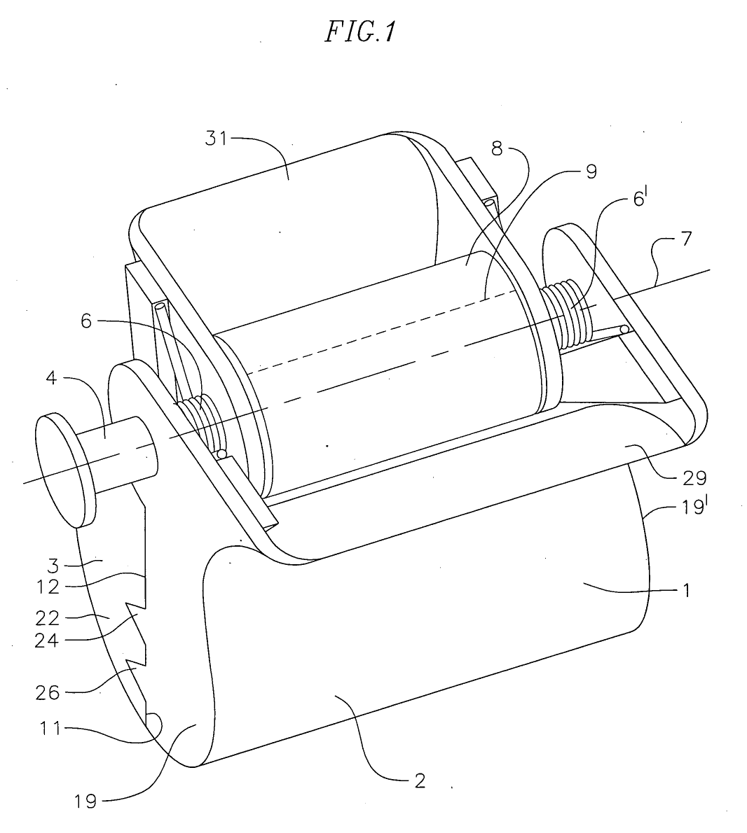

FIG. 1 is a perspective view of the handheld grappling device for animal excreta and illustrates the grappling device 1 in closed position. Grappling device 1 consists of a first body 2 and a second body 3 which represent a pair of jaws that are pivotally mounted to pin member 4 and biased by spring members 6 and 6¹ to a closed position. As can be seen by reference to FIG. 1, pin member 4 has a horizontal axis 7 where pin member 4 telescopically carries a roll of plastic container bags 8. A multiplicity of striations 9 separate each of the bags comprising the roll which permits the bag to be separated from the roll by a tearing motion.

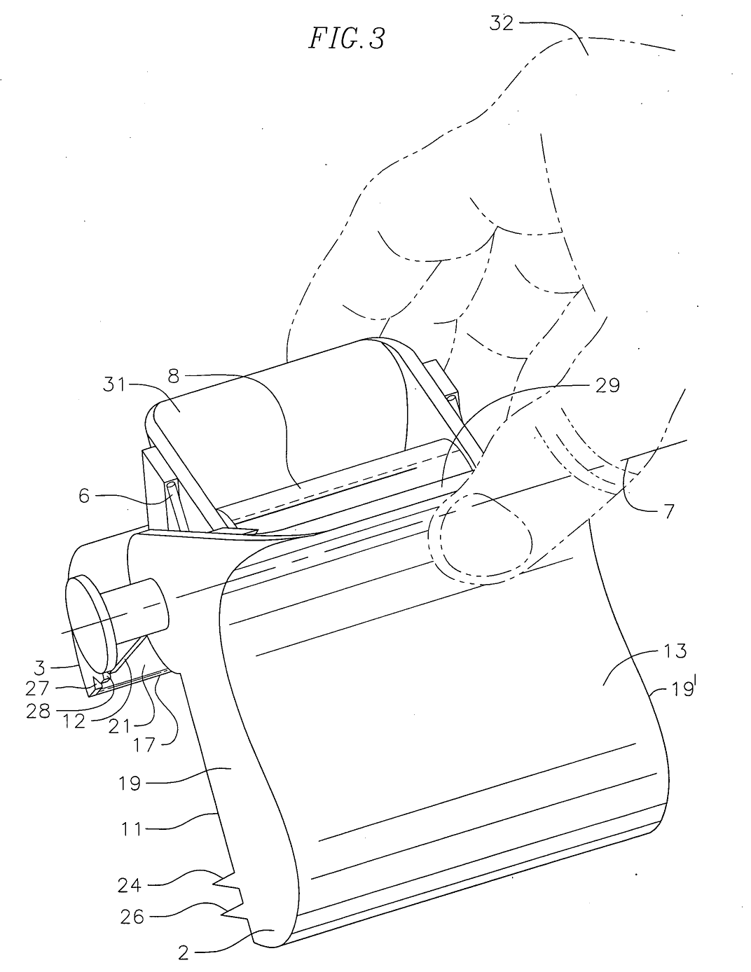

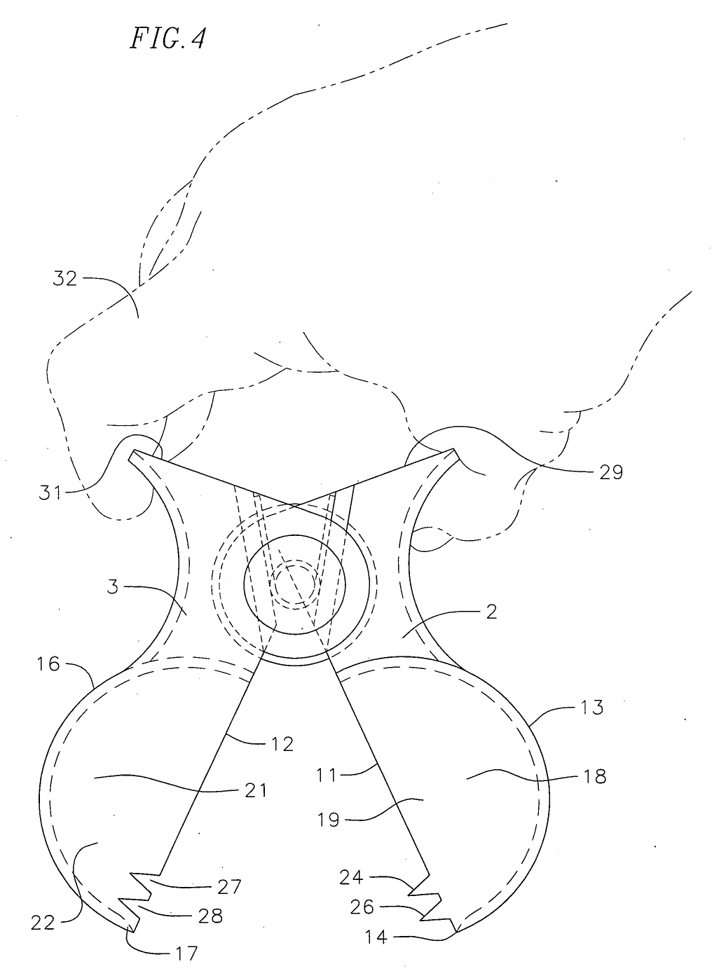

First body 2 and second body 3 are illustrated in the open position in FIGS. 3 and 4 and as can be seen in FIG. 3, first body 2 has first lateral edges 11 and 11¹ (lateral edge 11¹ not shown) and second body 3 has second lateral edges 12 and 12¹ (lateral edge 12¹ is not shown). These edges extend laterally and radially from the horizontal axis 7. As can further be seen in FIGS. 3 and 4, first body 2 has a first backwall 13 and a lower first edge 14; likewise, second body 3 has a second backwall 16 and a second lower edge 17. First and second lower edges 14 and 17 in the preferred embodiment are substantially parallel to horizontal axis 7, and by referring to FIG. 4, it can be seen that first lower edge 14 is tapered in the direction of the closed position and second lower edge 17 is tapered in the direction of the closed position which form a pincer type action when brought together in a compressive bearing relationship as illustrated in FIG. 1.

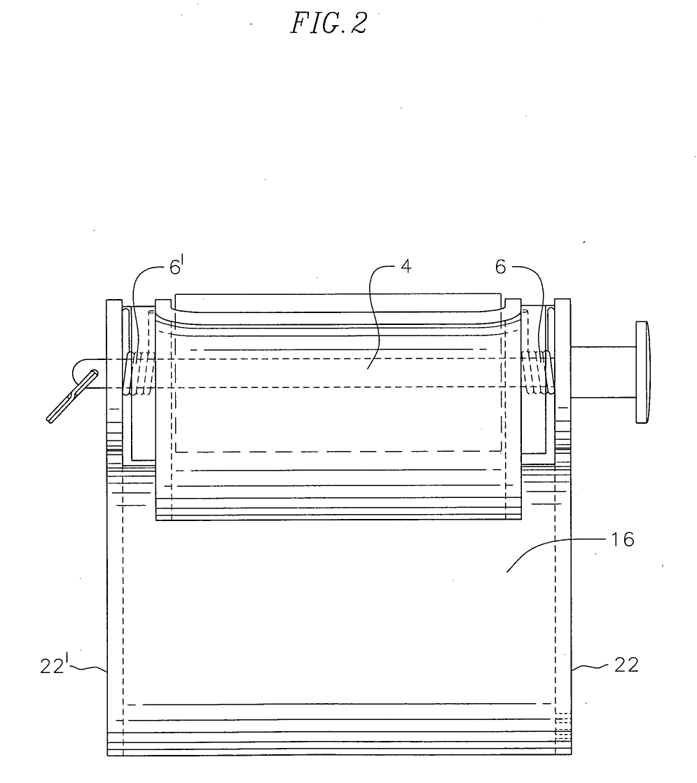

Both first body 2 and second body 3 have open regions which are bounded by the walls of each body. First open region 18 is bounded by first opposing sidewalls 19 and 19¹ and first backwall 13; and second open region 21 is bounded by second opposing sidewalls 22 and 22¹ and second backwall 16. By reference to FIGS. 1, 2, 3 it can be seen that first lateral edges 11 and 11¹ and lower first edge 14 are substantially in part in the same plane as are second lateral edges 12 and 12¹ and lower second edge 17. In the preferred embodiment of this invention, first lateral edges 11 and 11¹ contain saw-teeth projections 24 and 26 which mesh with matching saw-tooth indentations 27 and 28 when first body 2 and second body 3 are in the closed position. Thus, to more easily tear a plastic container bag from the roll 8 of plastic bags along striations 9, the container bag is positioned between first lateral edge 11 and second lateral edge 12 where that bag may be securely gripped by the saw-teeth projections.

Referring again to FIGS. 1, 3 and 4, it can be seen that first body 2 has a first flange 29 and second body 3 has a second flange 31 which permit grappling device 1 to be gripped by the user's hand 32 (shown in phantom). By applying opposing forces to the flanges, the user creates a torque about pin member 4 which causes first body 2 to be angularly displaced from second body 3 in a fashion that opens the jaws of the device (FIGS. 3 and 4). Torsion spring members 6 and 6¹ are rotationally compressed as first body 2 and second body 3 are angularly displaced and bias the bodies towards the closed position.

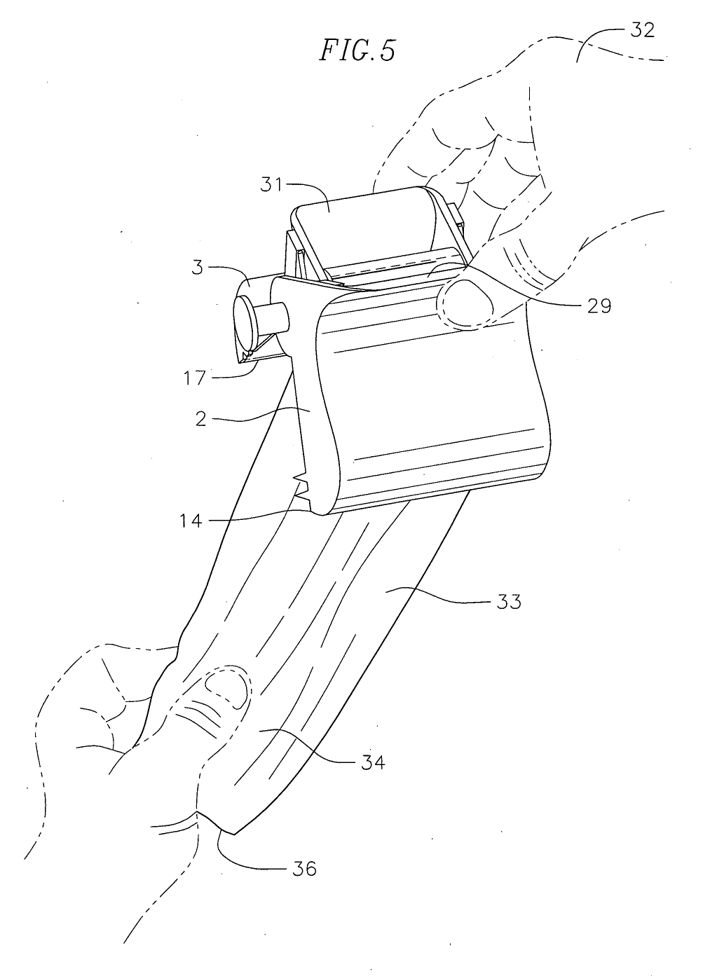

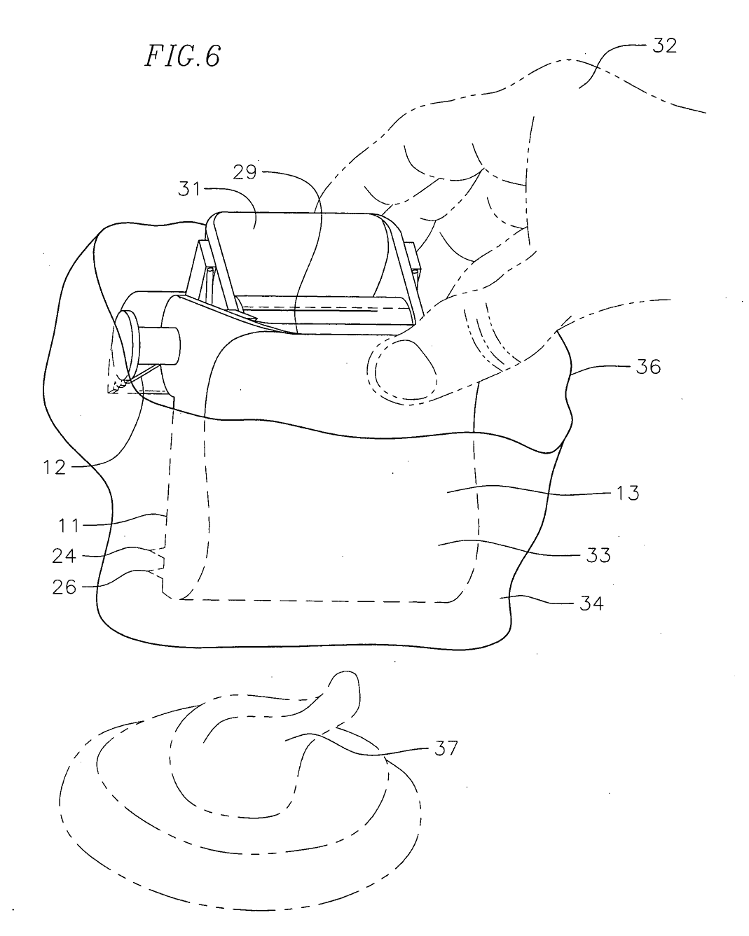

The preparation of grappling device 1 for use and the grappling process will now be described with reference to FIGS. 5, 6, and 7. As shown in FIG. 5, a plastic bag 33 is gripped by the user 32 and tangentially pulled from roll 8 with the leading edge portion 34 of the plastic bag 33 extending between and beyond lower first edge 14 and lower second edge 17. The leading edge 36 of leading edge portion 34 is a circumferentially open edge which may be overlapped over first body 2 and a second body 3 as shown in FIG. 6. Thus, with the leading edge portion 34 overlapping the first and second bodies and consequently reversed, the user by applying a force to first and second flanges 29 and 31, respectively, angularly displaces first body 2 from second body 3 such that first open region 18 and second open region 21 are positioned to straddle the animal excreta 37. Upon straddling the excreta 37, the user releases the force applied to flanges 29 and 31 which causes torsion springs 6 and 6¹ to apply a restoring force to first body 2 and second body 3 and bring the lower edge 14 and the lower second edge 17 into a compressive abutting relationship; the closure of the lower edges, which are tapered, scoops the excreta into the overlapped first edge portion 34 of plastic bag 33 where it is stored in part within both first open region 18 and second open region 21. The overlapping portion of plastic bag 33 which is external to the first and second bodies can then be tied to secure the excreta within plastic bag 33.

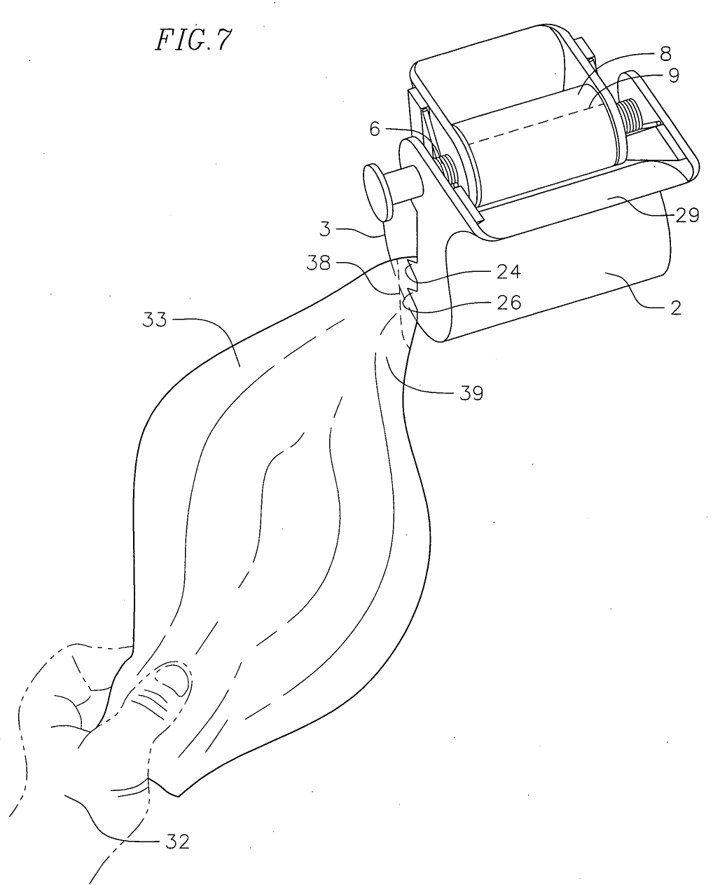

To remove the grappled excreta from the device, the user again applies a force to flanges 29 and 31 to angularly separate first lateral edges 11 and 11¹ from second lateral edges 12 and 12¹. With first body 2 and second body 3 so separated, a tangential force may be applied through plastic bag 33 to the roll of plastic container bags 8 until plastic container bag 33 and the separating striation 38 are external to first body 2 and second body 3. The succeeding plastic bag is now positioned such that the trailing edge portion 39 of plastic 33 is adjacent to the leading edge of the succeeding plastic bag. As can be seen in FIG. 7, saw-tooth projections 24 and 26 have meshed with saw-tooth indentations 27 and 28 and cinched the succeeding plastic bag such that plastic bag 33 may be torn along striation 38 to easily remove plastic bag 33 with excreta contents from the roll of plastic bags. The cinching of the succeeding bag permits separation to occur without the tearing of plastic bag 33 and the consequent spillage. The roll of plastic bags is so designed such that plastic bag 33 is sealed at striation 38 but the next succeeding bag's leading edge is circumferentially open.

While I have shown and described a grappling device for animal excreta, it is understood that the invention may be subject to many modifications without departing from the scope and spirit of the claims as recited herein.

What is claimed is:

1. A handheld device for grappling animal excreta, comprising:
(a) a pin member having a horizontal axis;
(b) a first body pivotally carried by said pin member having a first open region therein where said first open region is bounded by a pair of first opposing sidewalls having first lateral edges substantially orthogonal to said horizontal axis and a first backwall having a lower first edge substantially parallel to said horizontal axis, and where said first body is so dimensioned and proportioned such that said pair of said first lateral edge and said lower first edge are at least in part in the same plane;
(c) a second body pivotally carried by said pin member having a second open region therein where said second open region is bounded by a pair of second opposing sidewalls having second lateral edges substantially orthogonal to said horizontal axis and a second backwall having a lower second edge substantially parallel to said horizontal axis and juxtaposed to said lower first edge, and where said second body is so dimensioned and proportioned such that each said second lateral edge and said lower second edge are at least in part in the same plane;
(d) bias means responsive to angular displacement of said first body with respect to said second body said bias means associated with said pin member, said first body, and said second body, respectively, for restoring said lower first edge and said lower second edge into compressive bearing engagement;
(e) a multiplicity of flexible plastic container bags each said container bag having a leading edge portion and a trailing edge portion and so carried by said pin member to permit each one of said container bags to be sequentially advanced and positioned at least in part within said first and second open regions such the said leading edge portion may project between and overlap said lower first edge and said lower second edge respectively whereby upon sufficient angular displacement of said first body with respect to said second body, said excreta may be surrounded by said leading edge portion;
(f) said first lateral edge having a depression and said second lateral edge having an extension where said depression and said extension are at least in part in bearing relationship when said lower first edge and said lower second edge are in compressive bearing engagement to permit said trailing edge portion to be captively held and separated from the leading edge portion of the sequentially succeeding flexible plastic container bag.

2. The device recited in claim 1 wherein said lower first edge and said lower second edge are tapered.

3. The device recited in claim 2 where said first body and said second body have a laterally extending flange member, respectively, for angularly displacing said first body with respect to said second body.

4. The device recited in claim 3 where said multiplicity of flexible plastic container bags comprise a spool so carried by said pin member to permit rotation of said spool with respect to said pin member whereby sequentially succeeding said container bags may be advanced to a position at least in part within said first and second regions;

5. The device recited in claim 4 where said bias means comprises a spring;

6. The device recited in claim 1 where said depression is of a saw-tooth shape and said extension is so dimensioned and proportioned to permit said extension to mesh with said depression upon compressive bearing engagement of said lower first edge and said lower second edge.

7. The device recited in claim 6 wherein said lower first edge and said lower second edge are tapered.

8. The device recited in claim 7 where said first body and said second body have a laterally extending flange member respectively for angularly displacing said first body with respect to said second body.

9. The device recited in claim 8 where said multiplicity of flexible plastic container bags comprise a spool so carried by said pin member to permit rotation of said spool with respect to said pin member whereby sequentially succeeding said container bags may be advanced to a position at least in part within said first and second regions.

10. The device recited in claim 9 where said bias means comprises a spring.
